(19) United States
(12) Patent Application Publication
(10) Pub. No.: US 2006/0253497 A1
(43) Pub. Date: Nov. 9, 2006

(54) System and method for associating computational procedures with stored data objects

(76) Inventors: Bulent Abali, Tenafly, NJ (US); Mohammad Banikazemi, New York, NY (US); Cesar A. Gonzales, Katonah, NY (US); Jinpyo Kim, St. Paul, MN (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/120,485

(22) Filed: May 3, 2005

(51) Int. Cl. G06F 17/30

(52) U.S. Cl. 707/200

(57) ABSTRACT

A system and method for storing data objects in a storage device includes storing data objects where the data objects include associated main data and metadata that describes properties of the main data. Associated identifiers of computational procedures that can be applied to the main data are further included. Execution of the computational procedures associated with the data objects is also supported.

### BACKGROUND

1. Technical Field

The present invention relates to systems and methods for associating computational procedures with stored data objects, and more particularly to procedures which can be applied to such objects using nearby computational processing resources.

2. Description of the Related Art

With the advent of distributed file systems and particularly Internet-based storage systems (e.g., remote file storage or Internet virtual storage) data can be manipulated by computers located far away from the storage devices where they reside. In this environment, the performance of even simple computational tasks can be degraded because of the overhead of transferring data over the network. Moving computation closer to where the data is stored has been the main subject of a number of projects in the prior art. Some of the main contributions of the prior art will be briefly discussed.

Active Disks

In the paper by A. Acharya, M. Uysal, and J. Saltz, entitled “Active Disks: Programming Model, Algorithms and Evaluation,” Proc. Eighth Int'l Conf. Architectural Support for Programming Languages and Operating Systems, pp. 81-91, May 1998, the authors discuss the benefits of moving computation closer to where data is stored. In particular, the authors contend that the computational resources available in the microprocessors inside disk controllers could be used in aiding in computational tasks. The paper addresses issues involved in downloading and executing application-specific code in disk drives.

The major benefit in moving computation into disk drives is obtained when there are multiple disk drives and the computation is such that it can be performed in parallel. A programming model for disklets (which are programs that are executed in disk drives) is presented in this paper. Disklets work on input and output streams and have an initialization function which gets executed when a disklet is installed.

Active Disks (that is disks that can download and execute Disklets) require operating system (OS) support both at the host level and disk drive level. Simulation results show improvement in overall execution of the applications studied in the paper.

Dynamic Function Placement

In a paper by K. Amiri, D. Petrou, G. Ganger and G. Gibson, entitled “Dynamic function placement for data-intensive cluster computing”, Proc. USENIX Annual Technical Conference, San Diego, Calif., June 2000, the authors examine another approach for moving computation to where it can be executed most efficiently. In the proposed system, computation units are moved dynamically to achieve the best performance. To support such an idea, a new programming model has been devised.

In the proposed programming model programs are made of mobile objects. Mobile objects consist of states and methods, which operate on them. Each mobile object implements a few methods such that the runtime system can instantiate and possibly migrate it when needed. A migration is enacted only when the net benefit of the migration exceeds a configurable threshold. The net benefit is calculated using an analytical model where the cost of migration is also calculated.

Active Storage Framework

In the work by S. Anastasiadis, R. Wickremesinghe, J. Chase and J. Vitter, “Lerna—An Active Storage Framework for Flexible Data Access and Management”, Technical Report CS-2003-7, Department of Computer Science, Duke University, Durham, N.C., May 2003, the authors describe how the file interface can be used to perform application specific computation closer to where data is stored. In this approach, names of non-existent files are used to trigger the execution of predefined operations. File servers are enhanced such that they can intercept “open” commands to non-existing files.

After decoding the file name the servers execute the appropriate code and store the result in a file with the same name such that following accesses to the file can be executed. Parameters to code executed at the server can also be passed to the code through the file name.

### SUMMARY

One difference between the ideas presented in the prior art papers and the present invention is that in the present invention specific computational procedures are explicitly associated, e.g., tightly coupled, with specific data objects or files. Contrast this with arbitrary procedures which are chosen for offloading from main processing nodes to storage nodes with computational capabilities where the data resides. These procedures are then executed on data from storage devices or file servers, which are dynamically associated with the procedures.

In embodiments of the present invention, a computational procedure (or a handle to it) is embedded as a part of the storage objects or files. As a consequence, the embedded procedure can be invoked and executed on the associated data object or file by user applications or storage and file management software by simply invoking the object or file name and perhaps a tag to the procedure. The execution can be triggered by a command sent to the device or file or object server, or it can be scheduled for execution at a certain time, or it can be triggered in response to a hardware or software event. These and other mechanisms are not provided in the prior art.

A system and method for storing data objects in a storage device includes storing data objects. The data objects include associated main data and metadata that describes properties of the main data, and further include associated identifiers of computational procedures that can be applied to the main data. Execution of the computational procedures associated with the data objects is supported.

A file management system, includes memory storage for storing data objects. The data objects include associated main data and/or metadata that describe properties of the main data and associated identifiers of computational procedures that can be applied to the main data. A procedure runtime support module permits the computational procedures to execute in accordance with an event.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 illustrates a traditional system which can be evolved or extended such that computation can be moved to storage devices;

FIG. 2 illustrates a system which can be evolved or extended such that computation can be moved to storage devices in accordance with an aspect of the present invention;

FIG. 3 illustrates a system which is extended such that computation can be moved to storage devices;

FIG. 4 illustrates a basic storage element of Object-based Storage Device (OSD) and Active Object-based Storage Device (AOSD), which may be employed to support procedures in the data objects;

FIG. 5 illustrates a storage object having an embedded procedure in the active file system;

FIG. 6 illustrates native support for allocating storage space for storing procedures in a traditional block based file system in accordance with an embodiment of the present invention;

FIG. 7 shows an extension of traditional block based file system for storing procedures without modifying the existing file interface in accordance with another embodiment of the present invention; and

FIG. 8 is a block/flow diagram showing an illustrative system/method for storing and executing procedure associated with data objects.

### DETAILED DESCRIPTION OF PREFFERED EMBODIMENTS

The disclosed embodiments are useful in a distributed computing environment where the primary processing resources may be remotely connected to the data storage resources through a network of limited bandwidth and/or long latency. In such embodiments, even simple processing or storage management tasks may need to move lots of data throughout the network affecting network and application performance. By offloading a portion of the primary processing tasks to data-associated procedures, which can be executed near the data storage resources, network and application performance can be improved.

Furthermore, the procedures are preferably tightly coupled to data objects. Therefore, it is also possible to execute the procedure automatically under the supervision of a software scheduler or in response to environmental events, independent of the primary computing resources. This modality is useful for automatically collecting data access profiles, in optimization and in other storage management tasks.

By embodiments of the present invention, objects (and files) become self-contained as they include not only data and attributes, but also procedures and computations, which operate on the data and associated attributes. This feature makes it possible to transparently move an object through different layers and different devices while also carrying along the procedures through which data can be accessed. Additionally, this feature may be very important on systems with limited resources. In such systems, inclusion of access methods in objects can alleviate the need for system support for accessing and manipulating data.

The present invention is well suited for development of autonomic and self-managing storage systems. Collection, monitoring, and analysis of accesses to storage systems are desirable components of autonomic storage systems. These operations can be easily accomplished by utilizing procedures as described herein. In particular, data objects can be associated with access procedures, which collect and process access data. Furthermore, these procedures could be used to perform tasks such as moving data objects or pre-fetching data objects.

It should be noted that in object-oriented programming, objects are entities that incorporate data structures, attributes, data and procedures. It should also be noted that the objected oriented concept has been incorporated into other object-oriented technologies. However, “object oriented storage” technology has not included computational procedures as part of the storage objects, only data and attributes (See, e.g., M. Mesnier, G. Ganger, and E. Riedel, “Object-based storage”, IEEE Comm. Mag., August 2003), incorporated herein by reference.

This omission is non-trivial because in traditional distributed processing, computation in the form of procedures is thought of as independent of data. There are many useful scenarios for procedures that are automatically executed when data objects or files are invoked.

New methods and mechanisms are described which enable greater flexibility in moving computations closer to data. In particular, the present invention includes methods for hard-coding computational procedures with data objects. The present disclosure refers to storage systems that implement embodiments as Active Object-based Storage Devices (AOSD).

One embodiment utilizes a new type of file system and new storage devices that directly support AOSD. This file system is called, for ease of reference, an Active File System (AFS) and the new device an AOS Device (AOSD). Another embodiment shows how file systems found in the prior art can be extended to implement AOS using AOSDs. In another embodiment, AOSDs can be implemented by extending traditional (block-based) storage devices.

It should be understood that the elements shown in the FIGS. may be implemented in various forms of hardware, software or combinations thereof. Preferably, these elements are implemented in a combination of hardware and software on one or more appropriately programmed general-purpose digital computers having a processor and memory and input/output interfaces.

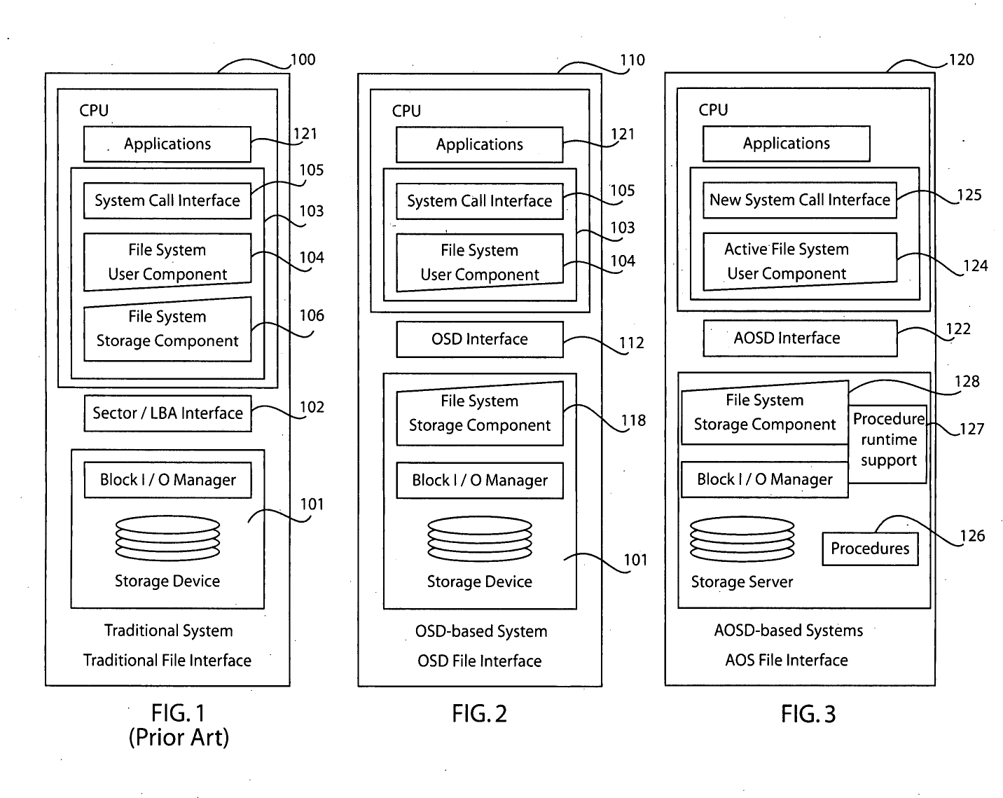

Referring now to the drawings in which like numerals represent the same or similar elements and initially to FIG. 1, a prior art model for storage management of block-based storage devices is illustratively shown. The prior art traditional file interface can be evolved into a model based on object storage devices (OSD) as developed by the Storage Networking Industry Association (SNIA) standards as shown illustratively in FIG. 2. Finally, FIG. 3 shows an illustrative model based on active object-based storage devices (AOSD) in accordance with embodiments of the present invention. FIGS. 1 and 2 and related explanation have been adapted from Mesnier et al.'s paper cited above.

FIG. 1 illustrates a traditional file system 100 in which block-based data storage devices 101 provide a narrow block-based interface (sector/LBA interface) 102 through which data can be accessed. In traditional storage devices, the device has no notion of files and there are no device-based mechanisms through which computational tasks can operate on data blocks. The notion of files as an aggregation of data blocks with common attributes is implemented in a file system 103 layer which is roughly made up of two components: a user component 104 that is responsible for presenting user applications with logical data structures, such as files and directories and a system call interface 105 for accessing these data structures; and a storage component 106 that maps the data structures to the physical storage.

FIG. 2 illustrates a system 110 proposed in the OSD standard that incorporates aspects of the present invention. In such a system, a physical storage management component 115 (and therefore the metadata) has been moved to the storage device 101. An object is thus a collection of one or more data blocks with a number of attributes about the data (the metadata). Accordingly the device interface is changed from blocks to objects in OSD interface 112.

Referring to FIG. 3, an OSD set up may be further enhanced to provide the infrastructure for moving computation to storage devices in a system 120. A new storage device called Active Object-based Storage Device (AOSD) provides an interface 122 for associating computation to storage objects and their execution. In illustrative embodiments of these systems, the notion of storage object is extended such that objects can include one or more procedures 126. Furthermore, AOSD provides the infrastructure for storing procedures and provides run time support 127 for execution of these procedures. The system 120 needs a new user component for a file system 124, a new storage component for the file system 128, and a new enhanced system call interface 125 which makes it possible for applications to take advantage of added functionalities.

It should be noted that although FIGS. 1, 2 and 3 illustrate one scenario in which applications and file systems execute in one computer processing unit (CPU), and this CPU directly interfaces with a storage device. This scenario does not limit the present invention. Instead, many system configurations may benefit by aspects of the present invention. For example, applications may access the storage devices through separate network file servers where the file systems reside. File servers, in turn, may connect to either direct-attached storage devices or to network-attached devices. The AOSD concept of FIG. 3 can be used in many diverse computation and storage distributed architectures.

Certain applications, such as database management software (DBMS), may directly access storage devices without the need of a file system. While we do not focus in these cases in this invention, it should be clear to any experienced in the art that the AOSD concepts could be extended to such applications. Active DBMS could include, for example, commonly used Structure Query Language (SQL) procedures to be executed in an AOSD.

Active Object-Cased Storage Device (AOSD)

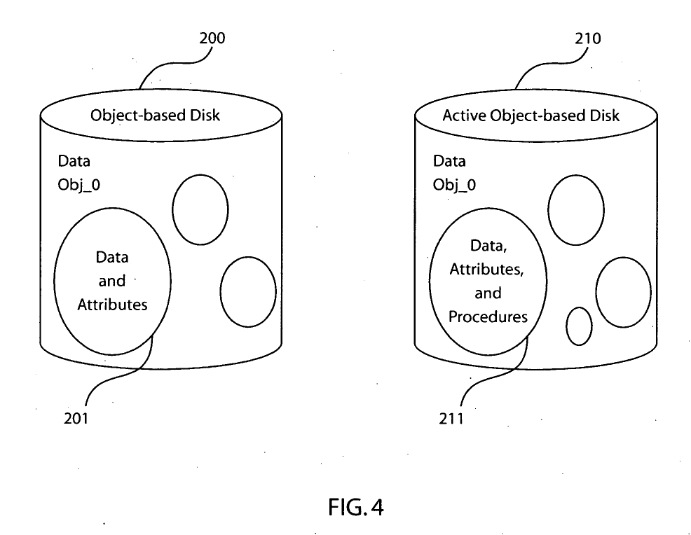

Referring to FIG. 4, a basic storage element of OSD 200 and AOSD 210 are illustratively shown. In one embodiment, OSD is enhanced such that an object is defined not only as a collection of data blocks and attributes 201 as in OSD 15 but as a collection of data blocks, attributes, and procedures 211.

Methods and mechanisms for associating attributes and procedures with an object during its creation time and/or later are supported by AOSD. Furthermore, AOSD provides the 20 run time support and mechanisms through which one or more procedures are executed. The execution of a procedure (211) can be triggered by a command received by the AOSD, or by some other hardware or software event. The execution can be immediate or delayed. Furthermore, AOSD may trigger the execution of well-defined procedures under the control of a scheduler which may be included in applications (121 of FIG. 3) or within AOSD. AOSD may also provide methods for associating procedures with object groups. An object group is a collection of one or more objects.

AOSD procedures 211 may be defined and/or provided by the AOSD manufacturer or by future standards. In addition, AOSD procedures may be defined by users of the AOSD, in which case there may be methods for verifying these procedures. Once the procedures are deemed to be executable, the procedures may be associated with their respective object or objects. AOSD procedures can be used to perform application dependent tasks. AOSD procedures can be also used for storage management purposes. Read and write operations can be implemented as pre-defined procedures.

AOSDs can be virtualized through, e.g., Volume Controllers (VC), which in turn are responsible for running procedures and aggregating their output when necessary. Procedures are marked such that the VC can recognize if a procedure can be executed across multiple AOSDs or VCs become responsible for executing the procedure on the whole object. VCs are typically part of the operating system and deal with accessing disk volumes and data blocks.

Active File System

In one embodiment, a file system is built on top of one or more AOSDs. The new file system illustratively called Active File System (AFS) takes advantage of AOSD properties and provides mechanisms for associating procedures to files and executing them. The current file system interfaces are enhanced such that applications can associate a procedure with a file and invoke it. The AFS will in turn prepare and transfer appropriate commands to one or more AOSDs for association of the procedure with corresponding object(s) and the execution of the procedure.

Note that the new files in an AFS will correspond to active objects in an AOSD, and that active objects, in turn, can be made up of multiple data objects and procedure objects. Take for example an “active multimedia object”, this object could be composed of a compressed “video” data object, an associated “video decompressor” procedure object, a compressed “audio” data object, an associated “audio decompressor” procedure object, a “subtitles” data object, a “synchronizer” procedure object or other objects. An invocation to the synchronizer procedure in the active multimedia object could trigger “reading” of decompressed video, audio and subtitle data in a predetermined multiplexed and synchronized pattern.

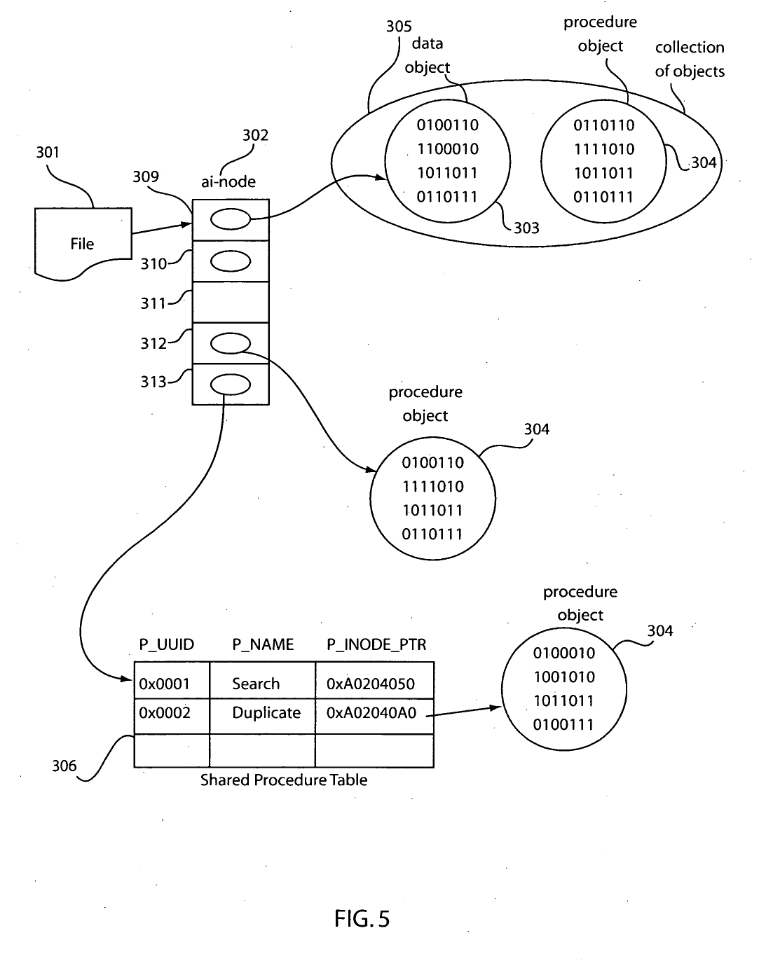

Referring to FIG. 5, one of many possible embodiments of an Active Object-based Storage Devices (OSD) interfaced to an AFS is illustratively shown. A file in the AFS environment is represented by a FILE 301. FILE 301 includes an ai-node 302 associated therewith, which defines which data objects and procedure objects are part of the file, by using entries 309-313, which include pointers to objects, etc. In traditional block based file systems, such as ext2 in Linux®, the storage component of the file system is implemented by the use of data structures called i-nodes and additional metadata which are the control structures inside a file system: free block maps, i-node maps, etc. i-nodes have direct and indirect block pointers to the blocks belonging to a file.

In this embodiment, a new type of i-node structure called an ai-node 302 is presented. A new ai-node can point to, e.g., data sub-objects 303, procedure sub-objects 304, paired-up data and procedure sub-objects 305, or pointers to data structures such as the “shared procedure table” 306 (used to point to procedures shared by multiple active objects). Note that the ai-node structure has pointers to sub-objects rather than to blocks as in prior art i-nodes.

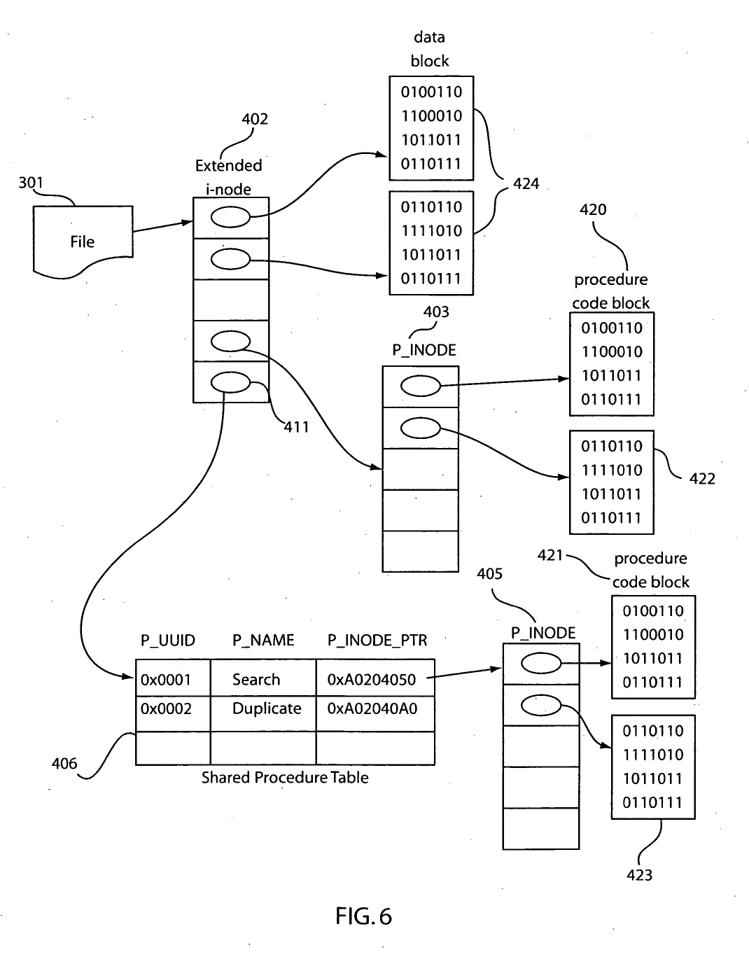

The structure of the shared procedure table will be explained later with reference to FIG. 6. It should be noted that the ai-nodes, the metadata and the runtime environment to execute the procedures in active objects would reside in the AOSD together with the data itself.

Procedures (e.g., procedure objects) may include executable binaries, scripts, or program codes that can be read and interpreted in run-time environments. User and system vendors can prepare storable procedures by compiling or writing scripts to store procedures as a-part of file.

Invoking a procedure in the file object can be done explicitly through a procedure access interface or can be triggered implicitly by certain conditions during scheduled time or file I/Os. Per-file customized procedures are loaded into memory and executed on the run-time environments when they are invoked. Shared procedures may be loaded into memory the first time of use and re-used afterward. Per-file customized procedures are associated when they are stored in the file.

In accordance with embodiments of the present invention, an active object may be turned into a self-managing and self-optimizing object by using implicit invocation. File management software simply activates the stored procedure by associating the files and management procedure. The associated procedure is then invoked implicitly by triggering conditions for optimization (e.g., file access pattern, quality of service requirement, storage placement, etc.) and conditions for management (e.g., expiring retention period, new security level enforcement for encryption, compression/decompression, etc.).

Extended File System

In yet another embodiment of the present invention, a new type of file system is provided which supports association of procedures with files and their execution. This group of extended file systems may be referred to as XFS. In such file systems, the file system is responsible for providing the run time support for execution of procedures when the underlying storage device is, for example, a prior art block-based or OSD. Furthermore, even if the underlying storage system is an AOSD, an XFS file system may choose the layer in which the procedure is executed. An XFS includes a method of preparing a procedure, transferring, storing, associating and executing the procedure.

Referring to FIG. 6, an extended i-node structure 402 for each file (e.g., FILE 301) of current file systems is extended to identify a location(s) where a procedure code(s) (e.g., 420, 421) is located. The extended i-node 402 structure may include identified locations for data blocks 424 and, in this example, two additional types of data fields: a pointer to P_INODE 403 and an index 411 to shared procedure table P_UID 406. P_INODE 403 has links to procedure code block 420 and attributes 422. The procedure attributes 422 have information for a loader (or interpreter). There may be two types of procedures stored in the file: Per-file procedure and shared procedure. A per-file customized procedure 420 is stored in the P_INODE. Shared procedures 421 are identified in a shared procedure table 406 and stored in a data structure P_INODE 405, which stores the procedures 421 and attributes 423 or points to a location where procedures 421 and attributes may be found. The shared procedures in table 406 (e.g., search and duplicate) may be accessed through a procedure access application program interface (API) (e.g., application 121, FIG. 3). The shared procedure table 406 can be stored where file metadata are stored.

It should be noted that procedures and attributes (e.g., 420 and 422) may include multiple storage data blocks on storage devices.

Procedures stored in the file may include executable binaries that can be loaded and executed (compiled binaries, e.g., search.o), scripts, or program codes that can be read and interpreted in the run-time environments. User and system vendors can prepare storable procedures by compiling or writing scripts to store procedures as a part of the file. Prepared procedures may be stored in the file as data before storing in the file.

The prepared procedure can be installed into the file through a procedure access API. Per-file customized procedure can be accessed in the same interface with a data-only file access interface (e.g., open( ), read( ), write( ), setattr( )), but it may employ additional flags (e.g., O_BRD, O_BWR, O_BEX). The prepared procedure can be installed into a shared procedure table (406) by using procedure access API (e.g., shared_procedure_table_register( ), shared_procedure_table_list( ), shared_procedure_table_deregister( ).

Invoking the procedure in the file object can be done explicitly through the procedure access API or can be triggered implicitly by certain conditions during scheduled times or file input/outputs (I/Os). Per-file customized procedures may be loaded into memory and executed on the run-time environments when they are invoked. Shared procedures may be loaded into memory at first use and re-used afterward. Per-file customized procedures may be associated when they are stored in the file. Shared procedures are associated dynamically when they are invoked by using P_UUID in table 406 stored in the extended INODE 402.

File objects may be self-managing and self-optimizing by using implicit invocation. File management software simply activates a stored procedure by associating the files and management procedure. The associated procedure is invoked implicitly by triggering conditions for optimization (e.g., file access pattern, QoS requirement, storage placement, and so on) and conditions for management (e.g., expiring retention period, new security level enforcement for encryption, compression/decompression, etc.).

Enhanced File System

In yet another embodiment, new system software is added to the file server system such that it complements the existing file system to provide support for association/execution of procedures. In this embodiment, the file system may be unchanged. A separate software component keeps track of the association between procedures and files and provides the needed runtime support for the execution of these procedures. A separate interface is used to initiate the association and execution of procedures.

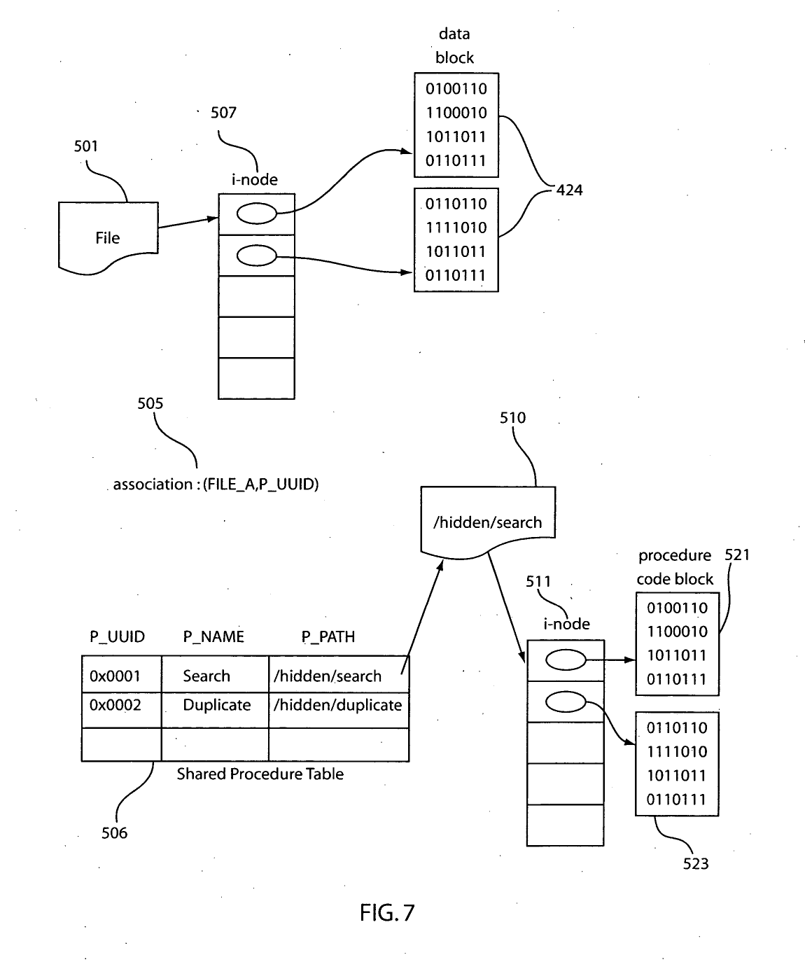

Referring to FIG. 7, an inventive extension of a traditional block-based file system for storing and invoking procedures without modifying the existing file interface is illustrated. New system software 125 (FIG. 3) is employed to provide any of the operations described herein and in particular, in this example, software 125 includes a shared procedure manager, which complements the existing file system with an additional procedure access interface. Traditional files in the file system 501 or 510 are associated with procedures 521 (and attributes 523) stored in an I-node 511 and represented in shared procedure table 506 through association rules 505. Each file 501 or 510 includes its own i-node 507 (for file 501) and i-node 511 (for file 510). It should be noted that procedures and attributes (e.g., 521 and 523) may include multiple storage data blocks on storage devices.

Shared procedure tables 506 may be initialized for storing the shared procedures that may be associated with a file or a collection of files. Procedures are stored as regular files e.g., file 510, and may or may not be stored in a directory invisible to application users.

At runtime, access to a file (e.g., FILE_A with P_UUID of 0×001) may invoke a procedure 521 (e.g., P_NAME=search or duplicate in this example) by accessing the procedure through the listed path (e.g., hidden/search).

I-node 507 may include pointers or information that indicates where data (e.g., data blocks 424) is-stored. Association information/rule 505 may be stored in data blocks 424 or other locations.

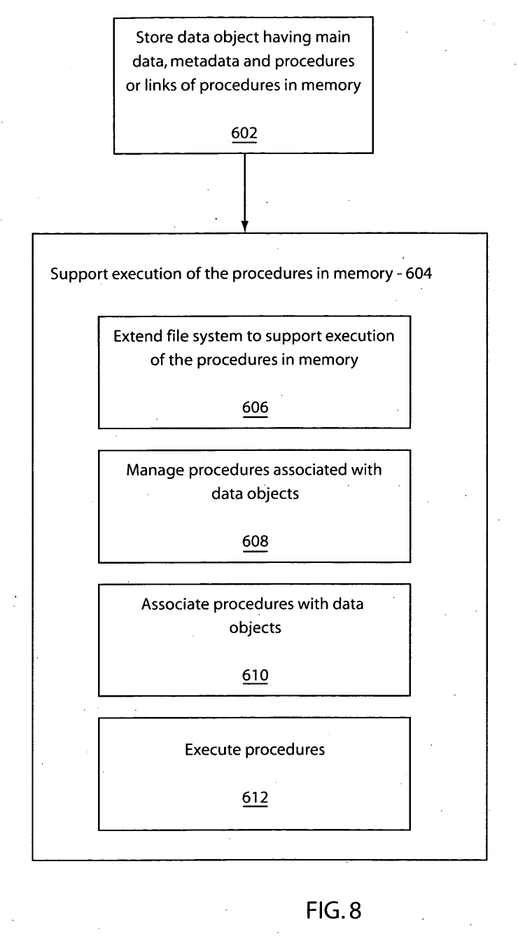

Referring to FIG. 8, a block/flow diagram shows an illustrative method for storing data objects with embedded procedures or handles to procedures. In block 602, data objects are stored. The data objects include associated main data and metadata that describes properties of the main data and associated identifiers of computational procedures or the procedures themselves that can be applied to the main data. In block 604, execution of the computational procedures associated with the data objects is supported. The following steps describe possible ways of supporting the executing and association of procedures with the data objects.

In block 606, a file system for storing the data objects may be extended to support execution of computational procedures. This may include, e.g., providing a shared procedure table to link procedure codes and attributes to the data objects or providing another association scheme to link the procedure to the data object. In block 608, procedures associated with stored data objects are managed. This may include managing runtime environment information for invoking an appropriate runtime loader and/or interpreter, or managing executable scripts, loadable binaries and/or program codes.

In block 610, a procedure may be associated with a stored data object, e.g., by explicit association by a user application or file manager, or by implicitly associating the procedure by file manager to the data object during file input/output operations according to a trigger condition.

In block 612, a procedure associated with a storage object may be executed. Execution may include, e.g., explicitly executing by user an application action, explicitly executing the procedure by a file system and/or implicitly executing the procedure as a result of internal conditions. Other events or triggers are also contemplated. The order of the blocks in FIG. 8 may be taken in any order, and are not limited to the illustrative order shown.

Having described preferred embodiments of a system and method for associating computational procedures with stored data objects (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for storing data objects in a storage device, comprising the steps of:
storing data objects including associated main data and metadata that describes properties of the main data and associated identifiers of computational procedures that can be applied to the main data; and
supporting execution of the computational procedures associated with the data objects.

2. The method as recited in claim 1, wherein the step of supporting includes extending a file system for storing the data objects to support execution of computational procedures.

3. The method as recited in claim 2, wherein the step of extending includes providing a shared procedure table to link procedure codes and attributes to the data objects.

4. The method as recited in claim 1, wherein the step of supporting includes managing procedures associated with stored data objects.

5. The method as recited in claim 4, wherein the step of managing includes managing runtime environment information for invoking an appropriate runtime loader and/or interpreter.

6. The method as recited in claim 4, wherein the step of managing includes managing executable scripts, loadable binaries and/or program codes.

7. The method as recited in claim 1, wherein the step of supporting includes associating a procedure with a stored data object by explicit association by a user application or file manager.

8. The method as recited in claim 1, wherein the step of supporting includes associating a procedure with a stored data object by implicitly associating the procedure by file manager to the data object during file input/output operations according to a trigger condition.

9. The method as recited in claim 1, wherein the step of supporting includes executing a procedure associated with a storage object.

10. The method as recited in claim 9, wherein the step of executing includes explicitly executing by user an application action.

11. The method as recited in claim 9, wherein the step of executing includes explicitly executing the procedure by a file system.

12. The method as recited in claim 9, wherein the step of executing includes implicitly executing the procedure as a result of internal conditions.

13. A program storage device readable by machine, tangibly embodying a program of instructions executable by the machine to perform method steps for storing data objects in a storage device, the method steps comprising:
storing data objects including associated main data and metadata that describes properties of the main data and associated identifiers of computational procedures that can be applied to the main data; and
supporting execution of the computational procedures of the data objects.

14. A file management system, comprising:
memory storage for storing data objects, the data objects including associated main data and/or metadata that describes properties of the main data and associated identifiers of computational procedures that can be applied to the main data; and
a procedure runtime support module, which permits the computational procedures to execute in accordance with an event.

15. The system as recited in claim 14, wherein the support module includes a shared procedure table to link procedure codes and attributes to the data objects.

16. The system as recited in claim 15, wherein the shared procedure table associates the procedure with the data object by specifying a pointer or a file path.

17. The system as recited in claim 14, wherein the computational procedure includes at least one of executable scripts, loadable binaries and/or program codes.

18. The system as recited in claim 14, further comprising a file manager which manages runtime environment information for invoking an appropriate runtime loader and/or interpreter and/or associates a procedure with a stored data object.

19. The system as recited in claim 14, wherein the event includes at least one of executing the procedure an application action or by a file system.

20. The system as recited in claim 14, wherein the event includes implicitly executing the procedure as a result of internal conditions.
